(19) United States
(12) Patent Application Publication
(10) Pub. No.: US 2006/0195527 A1
(43) Pub. Date: Aug. 31, 2006

(54) Limited-operation electronic mail accounts with set functions

(75) Inventors: Paul G. Allen, Seattle, WA (US); Edward K.Y. Jung, Bellevue, WA (US); Royce A. Levien, Lexington, MA (US); Mark A. Malamud, Seattle, WA (US); John D. Rinaldo JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/066,728

(22) Filed: Feb. 25, 2005

(51) Int. Cl. G06F 15/16

(52) U.S. Cl. 709/206

(57) ABSTRACT

In one aspect, a method related to a limited-operation electronic mail account. In addition to the foregoing, other method and system and program product aspects are described in the claims, drawings, and text forming a part of the present application.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. The present applicant entity has provided below a specific reference to the application(s) from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

Related Applications:

1. United States patent application entitled LIMITED-LIFE ELECTRONIC MAIL ACCOUNT AS INTERMEDIARY, naming Paul G. Allen; Edward K. Y. Jung; Royce A. Levien; Mark A. Malamud; and John D. Rinaldo, Jr. as inventors, U.S. application Ser. No. 11/041,894 filed Jan. 21, 2005, by express mail.

2. United States patent application entitled LIMITED-LIFE ELECTRONIC MAIL ACCOUNTS naming Paul G. Allen; Edward K. Y. Jung; Royce A. Levien; Mark A. Malamud; and John D. Rinaldo, Jr. as inventors, U.S. application Ser. No. 11/046,224 filed Jan. 28, 2005, by express mail.

### TECHNICAL FIELD

The present application relates, in general, to electronic mail.

### SUMMARY

In one aspect, a method related to electronic mail includes but is not limited to: creating a limited-operation electronic mail account having one or more defined operations; and detecting one or more occurrences related to the one or more defined operations. In addition to the foregoing, other method aspects are described in the claims, drawings, and text forming a part of the present application.

In one aspect, a system related to electronic mail includes but is not limited to: circuitry for creating a limited-operation electronic mail account having one or more defined operations; and circuitry for detecting one or more occurrences related to the one or more defined operations. In addition to the foregoing, other system aspects are described in the claims, drawings, and text forming a part of the present application.

In one or more various aspects, related systems include but are not limited to circuitry and/or programming and/or electromechanical devices and/or optical devices for effecting the herein-referenced method aspects; the circuitry and/or programming and/or electromechanical devices and/or optical devices can be virtually any combination of hardware, software, and/or firmware configured to effect the herein-referenced method aspects depending upon the design choices of the system designer skilled in the art.

In one aspect, a program product includes but is not limited to: a signal bearing medium bearing one or more instructions for creating a limited-operation electronic mail account having one or more defined operations, and one or more instructions for detecting one or more occurrences related to the one or more defined operations. In addition to the foregoing, other program product aspects are described in the claims, drawings, and text forming a part of the present application.

In one aspect, a method related to electronic mail includes but is not limited to receiving input from an account user related to a limited-operation electronic mail account having one or more defined operations; and transmitting a signal related to the limited-operation electronic mail account. In addition to the foregoing, other method aspects are described in the claims, drawings, and text forming a part of the present application.

In one aspect, a system related to electronic mail includes but is not limited to circuitry for receiving input from an account user related to a limited-operation electronic mail account having one or more defined operations; and circuitry for transmitting a signal related to the limited-operation electronic mail account. In addition to the foregoing, other system aspects are described in the claims, drawings, and text forming a part of the present application.

In one or more various aspects, related systems include but are not limited to circuitry and/or programming and/or electromechanical devices and/or optical devices for effecting the herein-referenced method aspects; the circuitry and/or programming and/or electromechanical devices and/or optical devices can be virtually any combination of hardware, software, and/or firmware configured to effect the herein-referenced method aspects depending upon the design choices of the system designer skilled in the art.

In one aspect, a program product includes but is not limited to a signal bearing medium bearing one or more instructions for receiving input from an account user related to a limited-operation electronic mail account having one or more defined operations; and one or more instructions for transmitting a signal related to the limited-operation electronic mail account. In addition to the foregoing, other program product aspects are described in the claims, drawings, and text forming a part of the present application.

In addition to the foregoing, various other method and/or system aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 is a flow chart depicts one implementation of an exemplary environment in which the methods and systems described herein may be represented.

FIG. 2 depicts a high-level logic flowchart of an operational process;

FIG. 3 illustrates several alternative implementations of the high-level logic flowchart of FIG. 2;

FIG. 4 shows several alternate implementations of the high level logic flowchart of FIG. 2;

FIG. 5 depicts several alternate implementations of the high-level logic flowchart of FIG. 2;

FIG. 6 illustrates several alternate implementations of the high-level logic flowchart of FIG. 2.

FIG. 7 shows several alternate implementations of the high-level logic flowchart of FIG. 2.

FIG. 8 shows several alternate implementations of the high-level logic flowchart of FIG. 2.

FIG. 9 depicts a high-level logic flowchart of an operational process.

FIG. 10 depicts a high-level logic flowchart of an operational process.

FIG. 11 depicts a high-level logic flowchart of an operational process.

The use of the same symbols in different drawings typically indicates similar or identical items.

### DETAILED DESCRIPTION

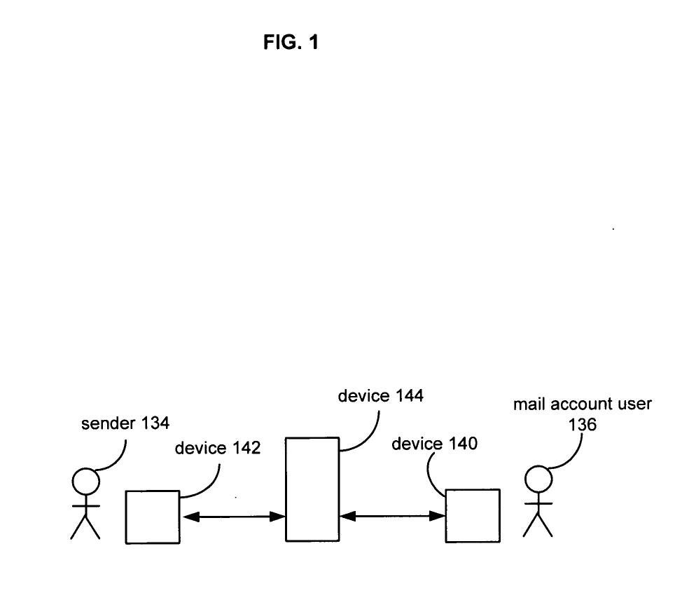

With reference to the figures, FIG. 1 depicts one implementation of an exemplary environment in which the methods and systems described herein may be represented. The sender 134 is the sender of an item of electronic mail to the limited-use electronic mail account user 136. The sender uses device 142, which may be a wireless handheld device, a laptop computer, a personal computer, a desk computer, a computer system terminal, or any other device capable of providing an interface between the sender 134 and an electronic mail account from which an item of electronic mail may be sent. The mail account user 136 uses a device 140, which may be a wireless handheld device, a laptop computer, a personal computer, a desk computer, a computer system terminal, or any other device capable of providing an interface between the mail account user 136 and an electronic mail account that may receive the item of electronic mail sent by the sender 134. Device 144 is exemplary of any and all intermediate devices that may provide paths and/or computational resources, e.g., one or more electronic mail servers and/or transmission media, to carry the item of electronic mail from the sender 134 to the limited-use electronic mail account user 136.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

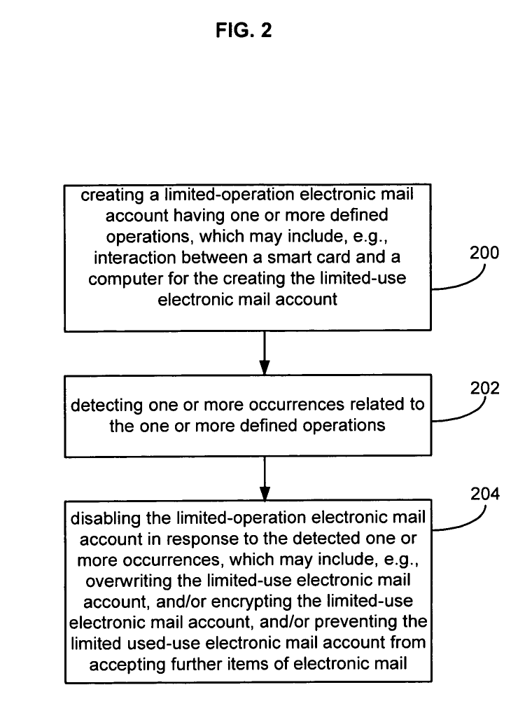

FIG. 2 depicts a high-level logic flowchart of an operational process. Operation 200 shows creating a limited-operation electronic mail account having one or more defined operations. Operation 202 depicts detecting one or more occurrences related to the one or more defined operations. Operation 204 illustrates disabling the limited-operation electronic mail account in response to the detected one or more occurrences. Illustrated is that operation 200 may include, e.g., interaction between a smart card and a computer for creating the limited-use electronic mail account. Those skilled in the art will recognize that, in addition to the smart card, in another implementation other email creation methodologies may be used, and such related art methodologies are not expressly recited here for sake of clarity.

The exemplary environment depicted in FIG. 1 can serve to illustrate examples of operations described herein. In one example illustrating operation 200, the account user 136 requests creation of a limited-operation electronic mail account, having one or more defined operations, by device 144 via the device 140; in response, device 144 creates the limited-operation electronic mail account having the one or more defined operations. In another example illustrating operation 200, device 144 automatically creates the limited-use electronic mail account having the one or more defined operations according to some defined pre-set criteria (e.g., creating a defined number of limited-use electronic mail accounts to be later utilized by assigned users). In one example illustrating operation 202, device 144 detects the one or more occurrences related to the one or more defined operations.

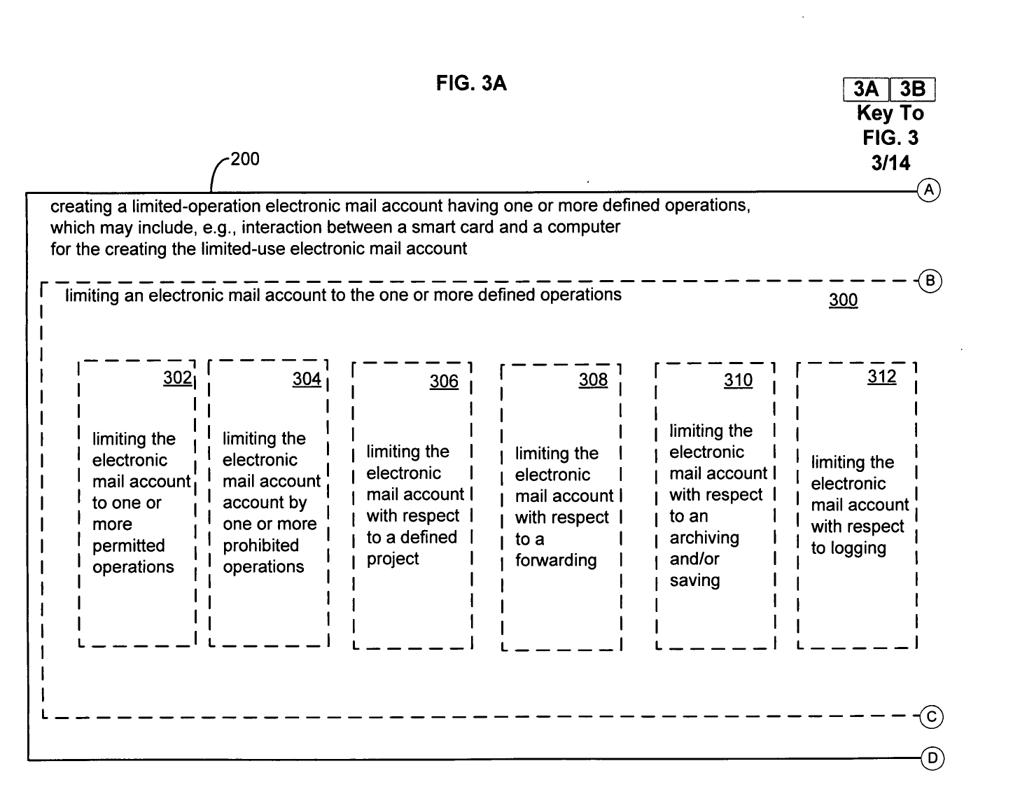

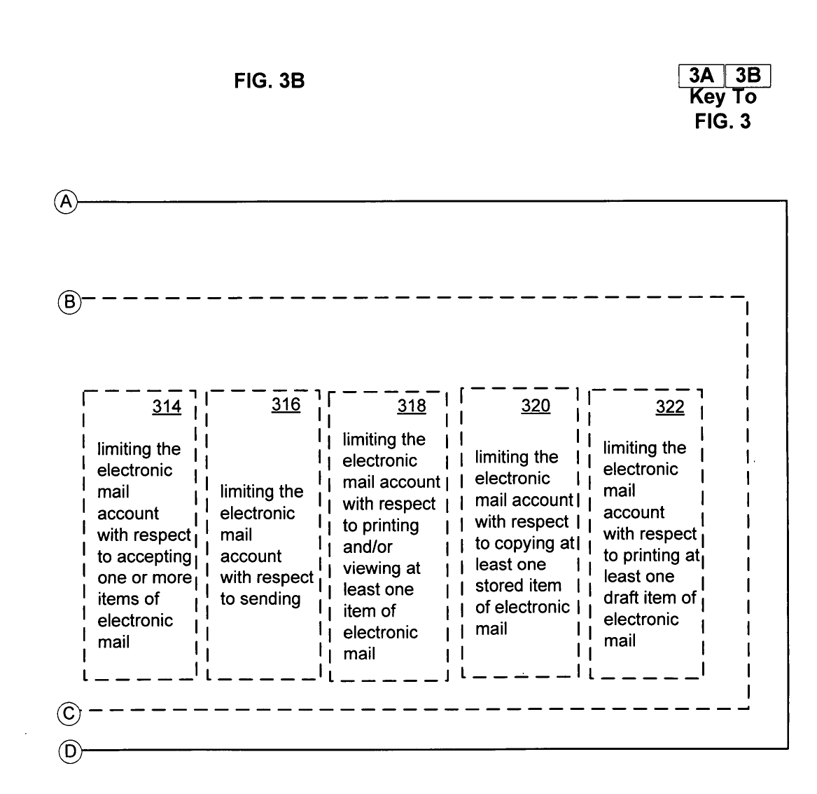

FIG. 3 illustrates several alternate implementations of the high-level logic flowchart of FIG. 2. Depicted is that in one alternative implementation, operation 200 includes operation 300, which illustrates limiting an electronic mail account to the one or more defined operations (e.g., via hardware/firmware/software embodied logic of device 144 limiting an account associated with mail account user 136 to accepting email from only a limited group of email addresses). Shown is that in other alternate implementations, operation 300 may include one or more of operations 302, 304, 306, 308, 310, 312, 314, 316, 318, 320, and/or 322. Operation 302 depicts limiting the electronic mail account to one or more permitted operations (e.g., via hardware/firmware/software embodied logic of device 144 limiting an account associated with mail account user 136 to forwarding email from only a limited group of email addresses). Operation 304 illustrates limiting the electronic mail account by one or more prohibited operations (e.g., via hardware/firmware/software embodied logic of device 144 authorizing an account associated with mail account user 136 to do everything but forward email from a limited group of email addresses to a limited group of email addresses). Operation 306 shows limiting the electronic mail account with respect to a defined project (e.g., via hardware/firmware/software embodied logic of device 144 directing an account associated with mail account user 136 to accept/not accept email containing a specified project identifier such as a specified phrase in the subject line or a specified attachment; or an account associated with mail account user 136 may be limited to accept/not accept email associated with a specified thread in a BBS or mail-based forum). Operation 308 shows limiting the electronic mail account with respect to a forwarding (e.g., via hardware/firmware/software embodied logic of device 144 directing an account associated with mail account user 136 to forward/not forward an email to a specified email account provided by mail account user 136). Operation 310 shows limiting the electronic mail account with respect to an archiving and/or saving (e.g., via hardware/firmware/software embodied logic of device 144 directing an account associated with mail account user 136 to send/not send an item of email to a specified place to be archived or saved). Operation 312 shows limiting the electronic mail account with respect to logging (e.g., via hardware/firmware/software embodied logic of device 144 directing an account associated with mail account user 136 to send/not send a blind (Bcc) copy to a Bcc email account existing to receive a copy of an email sent be a specified person or entity). Operation 314 shows limiting the electronic mail account with respect to accepting one or more items of electronic mail (e.g., via hardware/firmware/software embodied logic of device 144 directing an account associated with mail account user 136 to bounce/not bounce email from all but a limited group of email addresses). Operation 316 depicts limiting the electronic mail account with respect to sending (e.g., via hardware/firmware/software embodied logic of device 144 directing an account associated with mail account user 136 e.g., to allow/not allow a defined number of replies to an email received from a specific address and/or having a specific content, or, e.g., to allow/not allow reply to at least one received item of electronic mail, or, e.g., to allow/not allow sending from the mail account associated with mail account user 136 without a reply being possible). Operation 318 illustrates limiting the electronic mail account with respect to printing and/or viewing at least one item of electronic mail (e.g., via hardware/firmware/software embodied logic of device 144 communicating with hardware/firmware/software embodied logic of device 140 to allow/not allow printing and/or viewing of emails associated with defined groups of email addresses e.g., for a specified number of times and/or for a specified period of time). Operation 320 shows limiting the electronic mail account with respect to copying at least one item of electronic mail (e.g., via hardware/firmware/software embodied logic of device 144 communicating with hardware/firmware/software embodied logic of device 140 to allow copying of emails in defined storage classes and/or allowing/not allowing copying for a specified number of times and/or for a specified period of time). Operation 322 illustrates limiting the electronic mail account with respect to printing at least one draft item of electronic mail (e.g., via hardware/firmware/software embodied logic of device 144 communicating with hardware/firmware/software embodied logic of devices such as device 140 to allow/not allow printing of draft emails only by the drafter of the email (e.g., mail account user 136)). Other operations of the process shown in FIG. 3 are as described elsewhere herein.

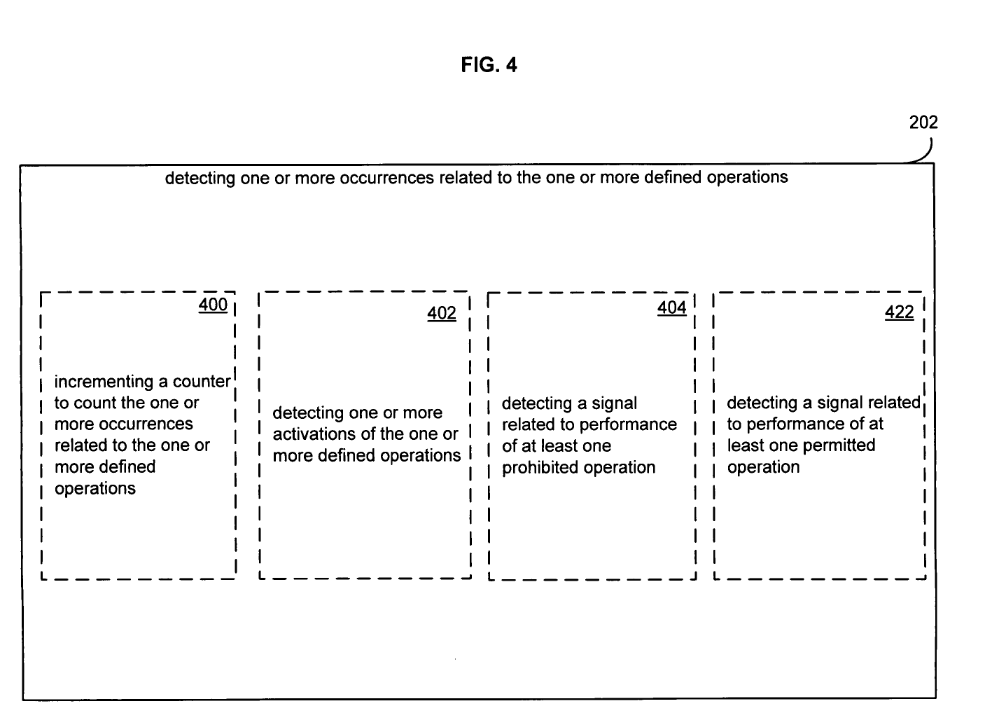

FIG. 4 shows several alternate implementations of the high-level logic flowchart of FIG. 2. Depicted is that in one alternative implementation, operation 202—detecting one or more occurrences related to the one or more defined operations—includes one or more of operations 400, 402, 404, and/or 406. Operation 400 depicts incrementing a counter to count the one or more occurrences related to the one or more defined operations (e.g., via hardware/firmware/software embodied counter logic of device 144 incrementing in response to one or more occurrences related to the one or more defined operations associated with various devices (e.g., device 142 and/or device 140 and the like). Operation 402 illustrates detecting one or more activations of the one or more defined operations (e.g., via hardware/firmware/software embodied logic of device 144 detecting one or more activations of the one or more electronic mail-related operations by various devices (e.g., by device 142 and/or device 140 and the like).

Operation 404 shows detecting a signal related to performance of at least one prohibited operation (e.g., via hardware/firmware/software embodied logic of device 144 detecting one or more signals related to one or more electronic mail-related operations from/in relation to various devices (e.g., by device 142 and/or device 140 and the like).

Operation 422 depicts detecting a signal related to performance of at least one permitted operation (e.g., via hardware/firmware/software embodied logic of device 144 detecting one or more signals related to performance of one or more operations related to electronic mail from/in relation to various devices (e.g., by device 142 and/or device 140 and the like). Other operations of the process shown in FIG. 4 are as described elsewhere herein.

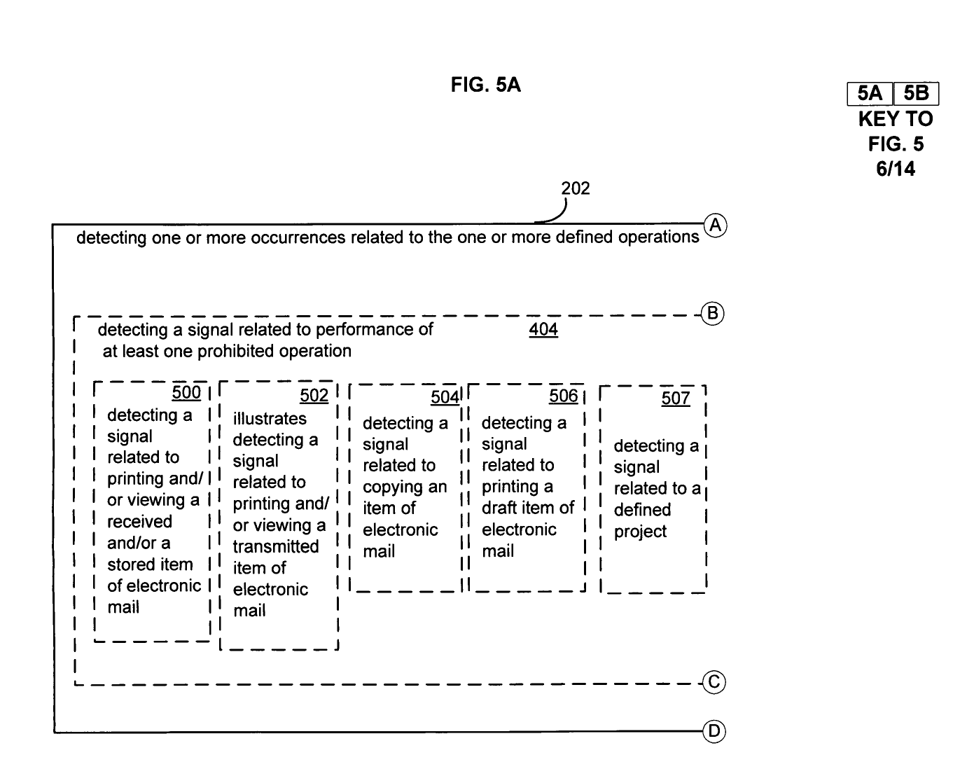

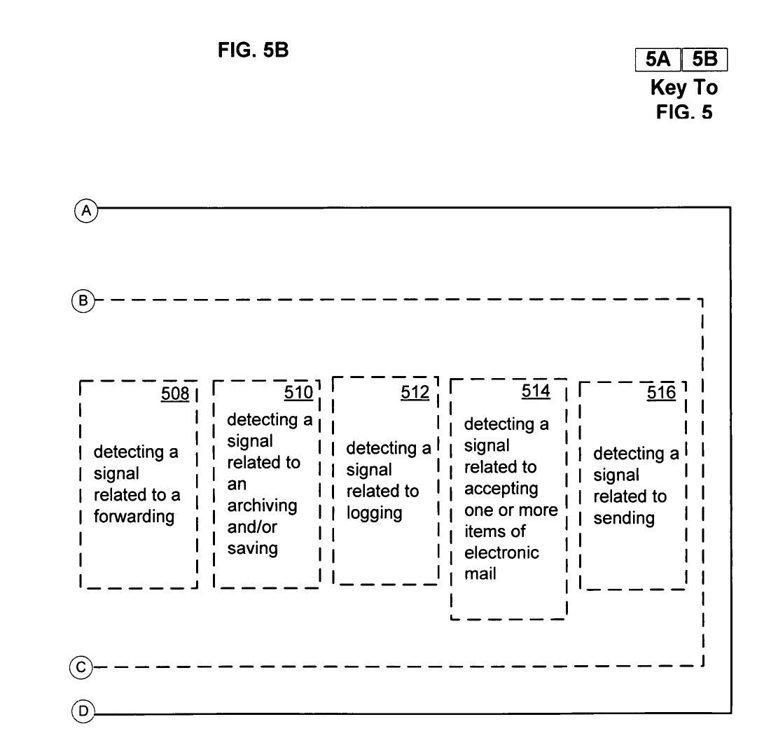

FIG. 5 depicts several alternate implementations of the high-level logic flowchart of FIG. 2. Depicted is that in one alternative implementation, operation 202—detecting one or more occurrences related to the one or more defined operations—includes one or more of operations 404, 500, 502, 504, 506, 507, 508, 510, 512, 514, and/or 516. Operation 404 illustrates detecting a signal related to performance of at least one prohibited operation (e.g., via hardware/firmware/software embodied logic of device 144 detecting one or more signals related to an attempt to engage in/actual performance of unauthorized printing of an item related to various devices (e.g., device 142 and/or device 140 and the like) and/or related to user ids associated with the various devices/people). Operation 500 depicts detecting a signal related to printing and/or viewing a received and/or a stored item of electronic mail (e.g., via hardware/firmware/software embodied logic of device 144 detecting one or more signals related to an attempt to engage in/actual performance of unauthorized printing/viewing of an item related to various devices (e.g., device 142 and/or device 140 and the like) and/or related to user ids associated with the various devices/people; via hardware/firmware/software embodied logic of device 144 communicating with hardware/firmware/software embodied logic of device 140 to detect a signal related to unauthorized printing and/or viewing of emails associated with defined groups of email addresses e.g., for a specified number of times or for a specified period of time). Operation 502 illustrates detecting a signal related to printing and/or viewing a transmitted item of electronic mail (e.g., via hardware/firmware/software embodied logic of device 144 detecting one or more signals related to an attempt to engage in/actual performance of unauthorized printing of an item transmitted to and/or by various devices (e.g., device 142 and/or device 140 and the like) and/or user ids associated with various devices/people). Operation 504 shows detecting a signal related to copying an item of electronic mail (e.g., via hardware/firmware/software embodied logic of device 144 detecting one or more signals related to an unauthorized attempt to engage in/actual performance of copying an item stored by various devices (e.g., device 144, device 142, and/or device 140 and/or an unauthorized copying of an item associated with user ids associated with various devices/people; via hardware/firmware/software embodied logic of device 144 communicating with hardware/firmware/software embodied logic of device 140 to detect a signal related to unauthorized copying of emails in defined storage classes)). Operation 506 depicts detecting a signal related to printing a draft item of electronic mail (e.g., via hardware/firmware/software embodied logic of device 144 detecting one or more signals related to an unauthorized attempt to engage in/actual performance of printing an item denoted as “draft” stored by various devices (e.g., device 144, device 142 and/or device 140 and the like) and/or an item denoted by user ids associated with various devices/people).

Operation 507 shows detecting a signal related to a defined project (e.g., via hardware/firmware/software embodied logic of device 144 detecting an attempt by an unauthorized user to access (e.g., send, receive, view, copy, etc.) email of a limited operation electronic mail account, where such detection is by a noted presence or absence of a project-identifying token such as a specified project identifier and/or a specified phrase in a subject line or an attachment to the email). Operation 508 shows detecting a signal related to a forwarding (e.g., via hardware/firmware/software embodied logic of device 144 detecting a prohibited attempt to forward an item of electronic mail of an electronic mail account, where the prohibition might entail a detected unauthorized recipient and/or unauthorized forwarder of the item of electronic mail). Operation 510 shows detecting a signal related to an archiving and/or saving (e.g., via hardware/firmware/software embodied logic of device 144 an unauthorized direction to archive or save a piece of electronic email of an electronic mail account). Operation 512 shows detecting a signal related to logging (e.g., via hardware/firmware/software embodied logic of device 144 detecting an unauthorized attempt by an electronic email account to log, e.g., to send a blind (Bcc) copy to a Bcc email account, a piece of electronic mail). Operation 514 shows detecting a signal related to accepting one or more items of electronic mail (e.g., via hardware/firrnware/software embodied logic of device 144 detecting an appearance of a piece of prohibited electronic mail and thereafter bouncing email from all but a limited group of email addresses). Operation 516 shows detecting a signal related to sending (e.g., via hardware/firmware/software embodied logic of device 144 detecting a signal related to an unauthorized sending/attempt to send an item of electronic mail to a prohibited address and/or having a prohibited content).

Other operations of the process shown in FIG. 5 are as described elsewhere herein.

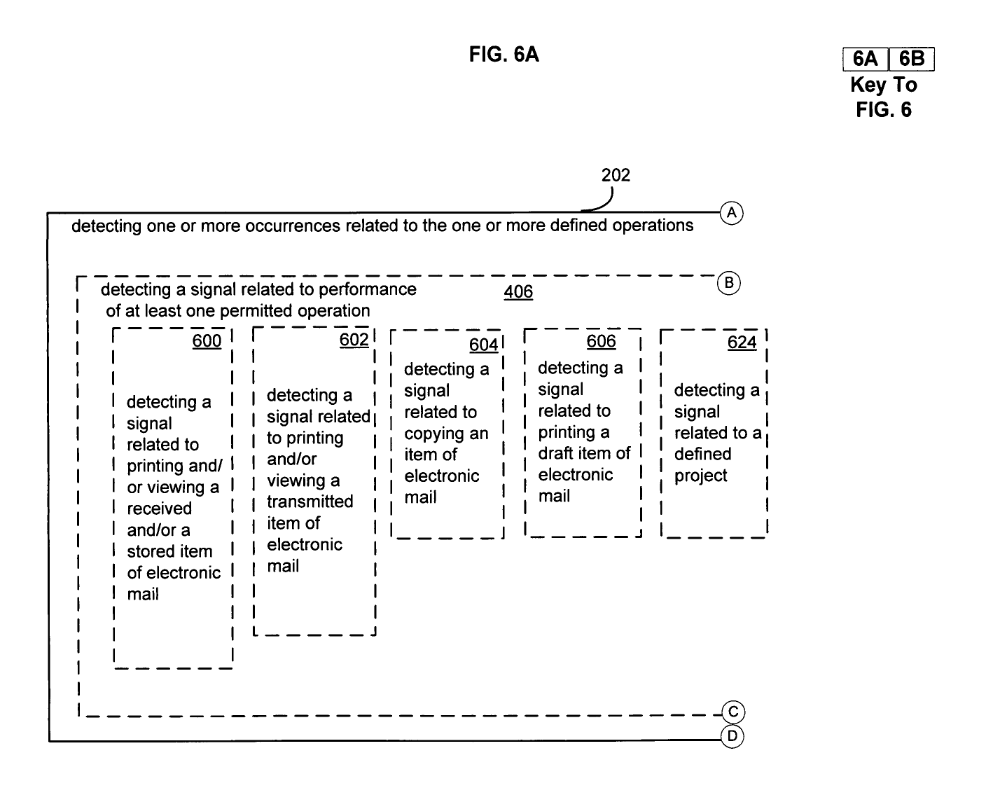

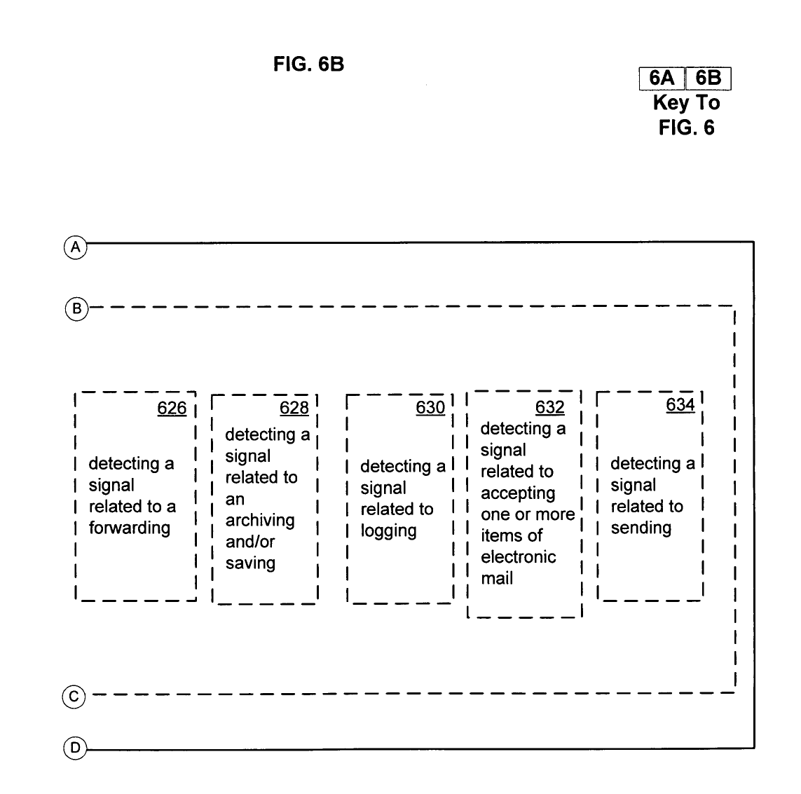

FIG. 6 illustrates several alternate implementations of the high-level logic flowchart of FIG. 2. Depicted is that in one alternative implementation, operation 202—detecting one or more occurrences related to the one or more defined operations—includes one or more of operations 406, 600, 602, 604, and/or 606, 624, 626, 628, 630, 632, and/or 634. Operation 406 illustrates detecting a signal related to performance of at least one permitted operation. Operation 600 depicts detecting a signal related to printing and/or viewing a received and/or a stored item of electronic mail (e.g., via hardware/firmware/software embodied logic of device 144 detecting an attempt/request to print an item at and/or received through various devices (e.g., device 144, device 142 and/or device 140 and the like) and/or related to user ids associated with the various devices/people). Operation 602 illustrates detecting a signal related to printing and/or viewing a transmitted item of electronic mail (e.g., via hardware/firmware/software embodied logic of device 144 detecting printing and/or viewing an item transmitted to and/or by various devices (e.g., device 142 and/or device 140 and the like) and/or transmitted to and/or by user ids associated with various devices/people). Operation 604 shows detecting a signal related to copying an item of electronic mail (e.g., via hardware/firmware/software embodied logic of device 144 detecting one or more signals related to copying an item stored by various devices (e.g., device 144, device 142 and/or device 140 and the like) and/or related to user ids associated with various devices/people). Operation 606 depicts detecting a signal related to printing a draft item of electronic mail (e.g., via hardware/firmware/software embodied logic of device 144 detecting one or more signals related to printing an item denoted as “draft” stored by various devices (e.g., device 144, device 142 and/or device 140 and the like) and/or related to user ids associated with various devices/people).

Operation 624 shows detecting a signal related to a defined project (e.g., via hardware/firmware/software embodied logic of device 144 directing acceptance of electronic mail items containing a specified project identifier such as a specified phrase in the subject line or a specified attachment, and/or a specified thread in a BBS/mail-based forum). Operation 626 shows detecting a signal related to a forwarding (e.g., via hardware/firmware/software embodied logic of device 144 detecting an attempted and/or actual forwarding of an email to a specified email account provided by mail account user 136). Operation 628 shows detecting a signal related to an archiving and/or saving (e.g., via hardware/firmware/software embodied logic of device 144 detecting either an actual and/or attempted archiving or saving of an identified item of electronic mail). Operation 630 shows detecting a signal related to logging (e.g., via hardware/firmware/software embodied logic of device 144 detecting an actual and/or attempted logging of an identified item of electronic mail, such as, e.g., detecting an attempted and/or actual sending of a blind (Bcc) copy to a Bcc email account existing to receive a copy of an email sent be a specified person or entity). Operation 632 shows detecting a signal related to accepting one or more items of electronic mail (e.g., via hardware/firmware/software embodied logic of device 144 detecting an appearance of one or more items of electronic mail and accepting the mail into a limited group of email addresses associated with the one or more items of electronic mail and/or notifying mail account user 136 of the accepted electronic mail). Operation 634 shows detecting a signal related to a sending (e.g., via hardware/firmware/software embodied logic of device 144 detecting an actual and/or attempted send a defined number of replies to an email received from a specific address and/or having a specific content, or, e.g., device 144 detecting an actual and/or attempted reply to at least one received item of electronic mail, or, e.g., device 144 detecting an actual or attempted send from a mail account which does not accept replies). Other operations of the process shown in FIG. 6 are as described elsewhere herein.

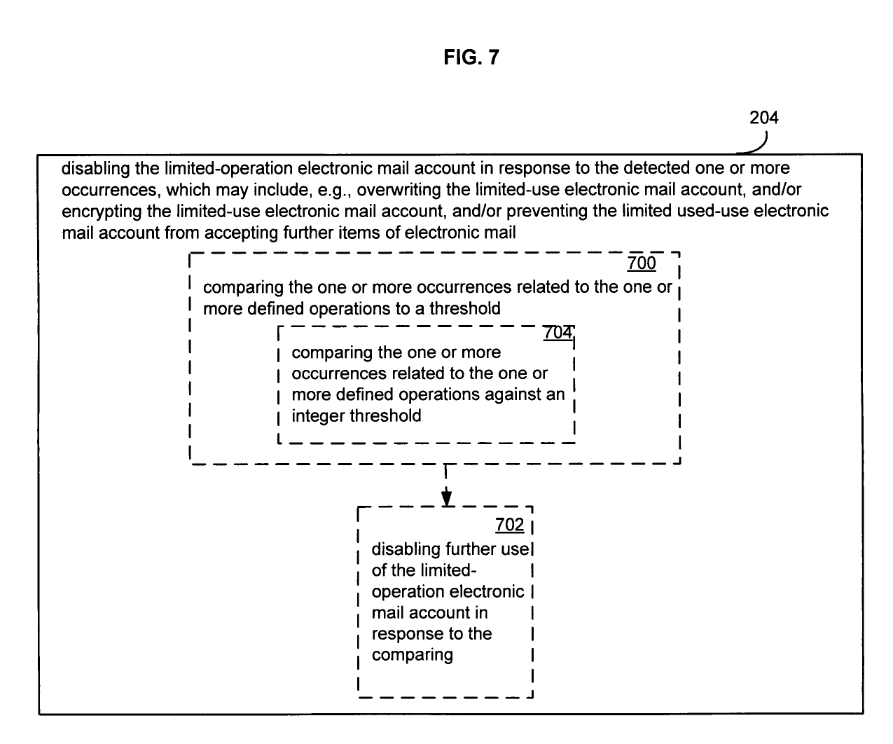

FIG. 7 shows several alternate implementations of the high-level logic flowchart of FIG. 2. Depicted is that in one alternative implementation, operation 204—disabling the limited-operation electronic mail account in response to the detected one or more occurrences—includes one or more of operations 700, 702, and/or 704. Operation 700 illustrates comparing the one or more occurrences related to the one or more defined operations to a threshold (e.g., via hardware/firmware/software embodied logic of device 144 comparing one or more detected attempts/requests to print an item at and/or received through various devices (e.g., device 144, device 142 and/or device 140 and the like) and/or user ids associated with the various devices/people against a defined threshold (e.g., comparing a number of forwarding against an upper limit of allowed forwardings to five separate email addresses)). Operation 702 depicts disabling further use of the limited-operation electronic mail account in response to the comparing (e.g., via hardware/firmware/software embodied logic of device 144 deactivating and/or encrypting and/or overwriting a electronic email account associated with various devices (e.g., device 144, device 142 and/or device 140 and the like) and/or user ids associated with the various devices/people). Operation 704 illustrates comparing the one or more occurrences related to the one or more defined operations against an integer threshold (e.g., via hardware/firmware/software embodied logic of device 144 comparing one or more detected attempts/requests to print an item at and/or received through various devices (e.g., device 144, device 142 and/or device 140 and the like) and/or user ids associated with the various devices/people against a defined number of allowed operations (e.g., an upper limit of 3 allowed printings)). Other operations of the process shown in FIG. 7 are as described elsewhere herein.

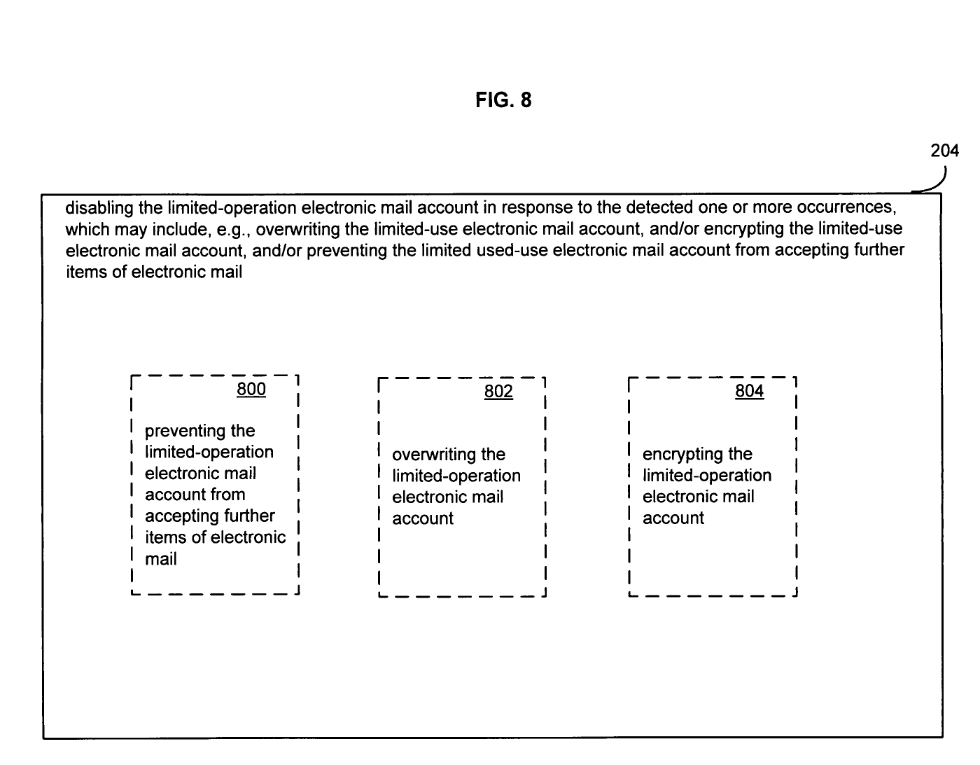

FIG. 8 shows several alternate implementations of the high-level logic flowchart of FIG. 2. Depicted is that in one alternative implementation, operation 204—disabling the limited-operation electronic mail account in response to the detected one or more occurrences—includes one or more of operations 800, 802, and/or 804. Operation 800 illustrates preventing the limited-operation electronic mail account from accepting further items of electronic mail (e.g., via hardware/firmware/software embodied logic of device 144 directing an electronic mail account to bounce emails from a defined group of addresses). Operation 802 shows overwriting the limited-operation electronic mail account (e.g., via hardware/firmware/software embodied logic of device 144 directing the overwriting with unrelated data an electronic mail account). Operation 804 shows encrypting the limited-operation electronic mail account (e.g., via hardware/firmware/software embodied logic of device 144 directing an electronic mail account to be encrypted). Other operations of the process shown in FIG. 8 are as described elsewhere herein.

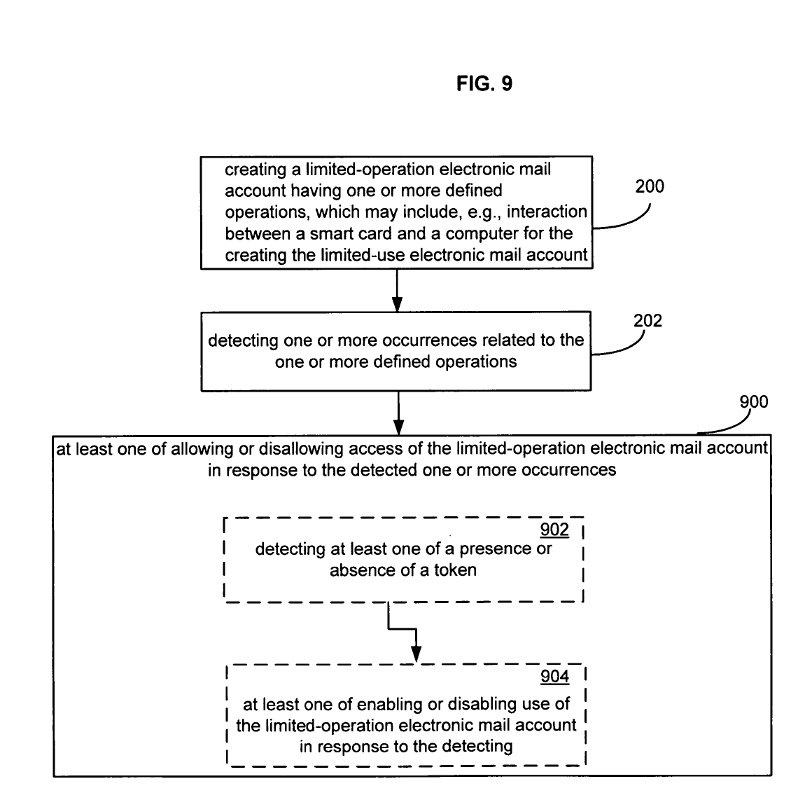

FIG. 9 depicts a high-level logic flowchart of an operational process. Operation 200 shows creating a limited-operation electronic mail account having one or more defined operations (e.g., hardware/firmware/software embodied logic of device 144 creating an electronic mail account that will accept email from a commercial entity associated with a check-out stand/commercial kiosk (not shown) in response to a message received from a robotic version of mail account user 136 (such as a computer program) associated with the check-out stand/commercial kiosk). Operation 202 depicts detecting one or more occurrences related to the one or more defined operations (e.g., hardware/firmware/software embodied logic of device 144 receiving one or more pieces of electronic mail containing advertisements addressed to the created electronic mail account that will accept email from a commercial entity associated with the check-out stand/commercial kiosk). Operation 900 depicts at least one of allowing or disallowing access of the limited-operation electronic mail account in response to the detected one or more occurrences. Operation 900 may include operations 902 and/or 904. Operation 902 shows detecting at least one of a presence or absence of a token (e.g., hardware/firmware/software embodied logic of device 144 detecting the presence and/or absence of a token indicative that the received email is associated with a robotic version of sender 134 in association with the commercial entity associated with a check-out stand/commercial kiosk). Operation 904 depicts at least one of enabling or disabling use of the limited-operation electronic mail account in response to the detecting (e.g., hardware/firmware/software embodied logic of device 144 accepting the received electronic mail into the created electronic mail account that will accept email from a commercial entity associated with the check-out stand/commercial kiosk if a requisite token relation is present or rejecting the received electronic mail from the account if the requisite token relation is absent). The token may be, e.g., associated with an activity such as logging on to a kiosk or opening a webpage, or associated with the contents of an email subject line or the presence of an attachment in an email.

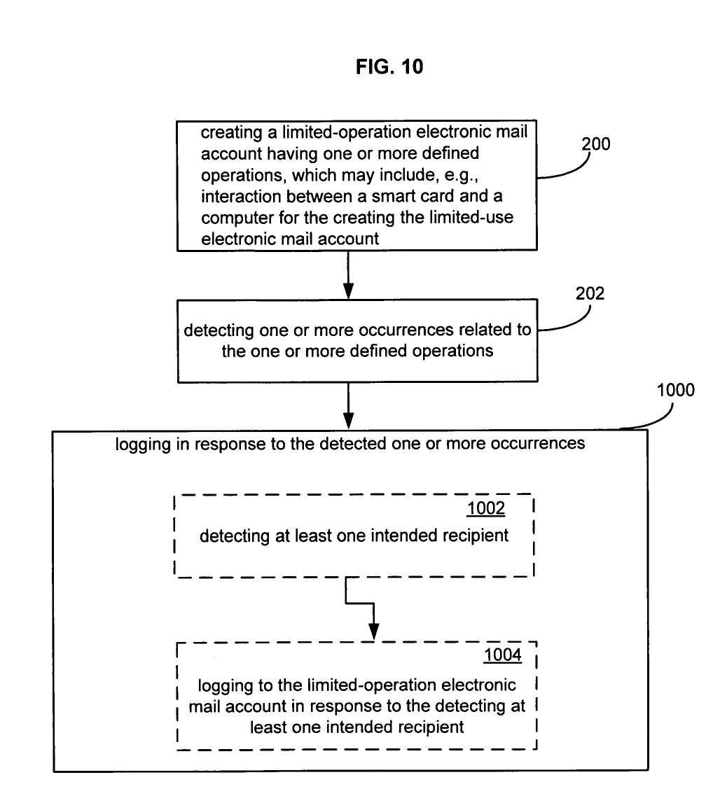

FIG. 10 depicts a high-level logic flowchart of an operational process. Operation 200 shows creating a limited-operation electronic mail account having one or more defined operations. Operation 202 depicts detecting one or more occurrences related to the one or more defined operations. Operation 1000 shows logging in response to the detected one or more occurrences. Operation 1000 may include operations 1002 and/or 1004. Operation 1002 shows detecting at least one intended recipient (e.g., via logic of device 144 detecting the presence or absence of specified information in a subject and/or addressee line (e.g., a sent to line, cc line, or bcc line). Operation 1004 depicts logging to the limited-operation electronic mail account in response to the detecting at least one intended recipient (e.g. via hardware/firmware/software embodied logic of device 144 directing an account associated with mail account user 136 to send/not send a blind copy (“BCC”) to a BCC email account that exists to receive a copy of an email sent by a specified person or entity).

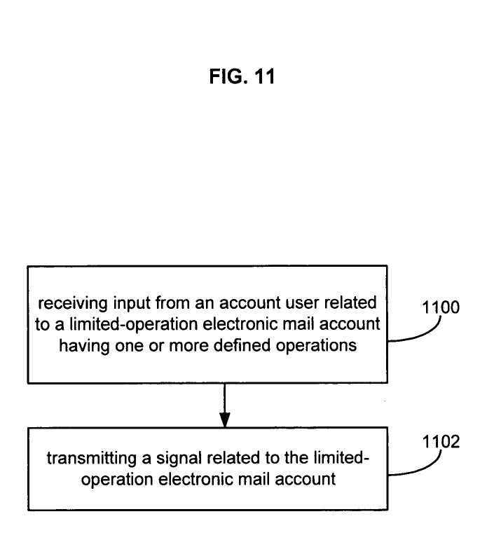

FIG. 11 depicts a high-level logic flowchart of an operational process. Operation 1100 shows receiving input from an account user related to a limited-operation electronic mail account having one or more defined operations (e.g., account user 136 requesting creation of a limited-operation electronic mail account, having one or more defined operations, via input accepted by the device 140). Operation 1102 depicts transmitting a signal related to the limited-operation electronic mail account (e.g., device 140 transmitting a request to create the limited-operation electronic mail account having the one or more defined operations to device 140).

Those skilled in the art will appreciate that the herein-described specific processes and/or devices and/or technologies are representative of more general processes and/or devices and/or technologies taught elsewhere herein, such as in the claims filed herewith and/or elsewhere in the present application.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use standard engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

1. A method related to electronic mail, the method comprising:
creating a limited-operation electronic mail account having one or more defined operations; and
detecting one or more occurrences related to the one or more defined operations.

2. The method of claim 1, wherein the creating a limited-operation electronic mail account having one or more defined operations further comprises:
limiting an electronic mail account to the one or more defined operations.

3. The method of claim 2, wherein the limiting an electronic mail account to the one or more defined operations further comprises:
limiting the electronic mail account to one or more permitted operations.

4. The method of claim 2, wherein the limiting an electronic mail account to the one or more defined operations further comprises:
limiting the electronic mail account by one or more prohibited operations.

5. The method of claim 2, wherein the limiting an electronic mail account to the one or more defined operations further comprises:
limiting the electronic mail account with respect to a defined project.

6. The method of claim 2, wherein the limiting an electronic mail account to the one or more defined operations further comprises:
limiting the electronic mail account with respect to a forwarding.

7. The method of claim 2, wherein the limiting an electronic mail account to the one or more defined operations further comprises:
limiting the electronic mail account with respect to an archiving and/or a saving.

8. The method of claim 2, wherein the limiting an electronic mail account to the one or more defined operations further comprises:
limiting the electronic mail account with respect to logging.

9. The method of claim 2, wherein the limiting an electronic mail account to the one or more defined operations further comprises:
limiting the electronic mail account with respect to accepting one or more items of electronic mail.

10. The method of claim 2, wherein the limiting an electronic mail account to the one or more defined operations further comprises:
limiting the electronic mail account with respect to sending.

11. The method of claim 2, wherein the limiting an electronic mail account to the one or more defined operations further comprises:
limiting the electronic mail account with respect to printing and/or viewing at least one item of electronic mail.

12. The method of claim 2, wherein the limiting an electronic mail account to the one or more defined operations further comprises:
limiting the electronic mail account with respect to copying at least one item of electronic mail.

13. The method of claim 2, wherein the limiting an electronic mail account to the one or more defined operations further comprises:
limiting the electronic mail account with respect to printing at least one draft item of electronic mail.

14. (canceled)

15. (canceled)

16. The method of claim 1, wherein the detecting one or more occurrences related to the one or more defined operations further comprises:
detecting one or more activations of the one or more defined operations.

17. The method of claim 1, wherein the detecting one or more occurrences related to the one or more defined operations further comprises:
detecting a signal related to performance of at least one prohibited operation.

18. The method of claim 17, wherein the detecting a signal related to performance of at least one prohibited operation comprises:
detecting a signal related to a defined project.

19. The method of claim 17, wherein the detecting a signal related to performance of at least one prohibited operation comprises:
detecting a signal related to a forwarding.

20. The method of claim 17, wherein the detecting a signal related to performance of at least one prohibited operation comprises:
detecting a signal related to an archiving and/or a saving.

21. The method of claim 17, wherein the detecting a signal related to performance of at least one prohibited operation comprises:
detecting a signal related to logging.

22. The method of claim 17, wherein the detecting a signal related to performance of at least one prohibited operation comprises:
detecting a signal related to accepting one or more items of electronic mail.

23. The method of claim 17, wherein the detecting a signal related to performance of at least one prohibited operation comprises:
detecting a signal related to sending.

24. The method of claim 17, wherein the detecting a signal related to performance of at least one prohibited operation comprises:
detecting a signal related to printing and/or viewing an item of electronic mail.

25. The method of claim 17, wherein the detecting a signal related to performance of at least one prohibited operation comprises:
detecting a signal related to copying an item of electronic mail.

26. The method of claim 1, wherein the detecting one or more occurrences related to the one or more defined operations further comprises:
detecting a signal related to performance of at least one permitted operation.

27. The method of claim 26, wherein the detecting a signal related to performance of at least one permitted operation comprises:
detecting a signal related to a defined project.

28. The method of claim 26, wherein the detecting a signal related to performance of at least one permitted operation comprises:
detecting a signal related to a forwarding.

29. The method of claim 26, wherein the detecting a signal related to performance of at least one permitted operation comprises:
detecting a signal related to an archiving and/or a saving.

30. The method of claim 26, wherein the detecting a signal related to performance of at least one permitted operation comprises:
detecting a signal related to logging.

31. The method of claim 26, wherein the detecting a signal related to performance of at least one permitted operation comprises:
detecting a signal related to accepting one or more items of electronic mail.

32. The method of claim 26, wherein the detecting a signal related to performance of at least one permitted operation comprises:
detecting a signal related to sending.

33. The method of claim 26, wherein the detecting a signal related to performance of at least one permitted operation comprises:
detecting a signal related to printing and/or viewing an item of electronic mail.

34. The method of claim 26, wherein the detecting a signal related to performance of at least one permitted operation comprises:
detecting a signal related to copying an item of electronic mail.

35. The method of claim 1, further comprising:
disabling the limited-operation electronic mail account in response to the detected one or more occurrences.

36. The method of claim 35, wherein the disabling the limited-operation electronic mail account in response to the detected one or more occurrences comprises:
comparing the one or more occurrences related to the one or more defined operations to a threshold; and
disabling further use of the limited-operation electronic mail account in response to the comparing.

37. The method of claim 36, wherein the comparing the one or more occurrences related to the one or more defined operations to a threshold comprises:
comparing the one or more occurrences related to the one or more defined operations against an integer threshold.

38. The method of claim 35, wherein the disabling the limited-operation electronic mail account in response to the detected one or more occurrences comprises:
at least one of overwriting the limited-operation electronic mail account or encrypting the limited-operation electronic mail account.

39. The method of claim 35, wherein the disabling the limited-operation electronic mail account in response to the detected one or more occurrences comprises:
preventing the limited-operation electronic mail account from accepting further items of electronic mail.

40. The method of claim 1, further comprising:
at least one of allowing or disallowing access of the limited-operation electronic mail account in response to the detected one or more occurrences.

41. The method of claim 40, wherein the at least one of allowing or disallowing access of the limited-operation electronic mail account in response to the detected one or more occurrences comprises:
detecting at least one of a presence or absence of a token; and
at least one of enabling or disabling use of the limited-operation electronic mail account in response to the detecting.

42. The method of claim 1, further comprising:
logging in response to the detected one or more occurrences.

43. The method of claim 42, wherein the logging in response to the detected one or more occurrences comprises:
detecting at least one intended recipient of an email; and
logging to the limited-operation electronic mail account in response to the detecting at least one intended recipient.

44. A system related to electronic mail, the system comprising:
circuitry for creating a limited-operation electronic mail account having one or more defined operations; and
circuitry for detecting one or more occurrences related to the one or more defined operations.

45. (canceled)

46. (canceled)

47. (canceled)

48. (canceled)

49. (canceled)

50. (canceled)

51. (canceled)

52. (canceled)

53. (canceled)

54. (canceled)

55. A system comprising:
means for creating a limited-operation electronic mail account having one or more defined operations; and
means for detecting one or more occurrences related to the one or more defined operations.

56. (canceled)

57. A program product, comprising:
a signal bearing medium bearing
one or more instructions for creating a limited-operation electronic mail account having one or more defined operations, and
one or more instructions for detecting one or more occurrences related to the one or more defined operations.

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. A method related to electronic mail, the method comprising:
receiving input from an account user related to a limited-operation electronic mail account having one or more defined operations; and
transmitting a signal related to the limited-operation electronic mail account.

71. (canceled)

72. (canceled)

73. A program product, comprising:
a signal bearing medium bearing one or more instructions for receiving input from an account user related to a limited-operation electronic mail account having one or more defined operations; and
one or more instructions for transmitting a signal related to the limited-operation electronic mail account.

74. (canceled)

75. (canceled)
